(19) United States
(12) Patent Application Publication
(10) Pub. No.: US 2020/0223762 A1
(43) Pub. Date: Jul. 16, 2020

(54) COMPOSITION OF HUMIC ACID MICROEMULSIONS FOR AGRICULTURAL FERTILIZERS AND METHODS FOR MAKING SAME

(71) Applicant: Wilbur-Ellis Company LLC, San Francisco, CA (US)

(72) Inventor: VINCENT J. YOVINO, FRESNO, CA (US)

(73) Assignee: Wilbur-Ellis Company LLC, San Francisco, CA (US)

(21) Appl. No.: 16/740,298

(22) Filed: Jan. 10, 2020

Related U.S. Application Data
(60) Provisional application No. 62/792,490, filed on Jan. 15, 2019.

(51) Int. Cl. C05F 11/02; C05G 5/27

(52) U.S. Cl. CPC C05F 11/02; C05G 5/27

(57) ABSTRACT

A humic acid fertilizer with improved functional compatibility, and methods for making same. The present humic acid fertilizer may be combined with other fertilizers of all pH, EC, and concentrations, for later application of the integrated fertilizer. Humic acid particles are first emulsified using a microemulsion process, in which ore is chemically extracted and then mixed with tall oil and amino primary alcohol. The emulsified humic acid is later combined with a carboxylic acid. Finally, the acidic solution is settled and refined, preferably using one or more stages of centrifuge separation.

### PRIORITY CLAIM

Pursuant to the provisions of 35 U.S.C. Section 119(e), Applicant claims the priority of his U.S. Provisional Patent Application No. 62/792,490, filed Jan. 15, 2019. 1

### BACKGROUND OF THE INVENTION

### 1. Field of the Invention

The invention relates to the chemical class of compounds known as humic acids for use as agricultural fertilizers, which improve the properties and growing performance of plants and other agricultural comestibles. More particularity, the invention pertains to humic acid microemulsion compositions, and the processes by which such fertilizer compositions are made.

### 2. Description of the Prior Art

Fertilizers used in agriculture may be added indirectly to crops either through injection or by application to the soil in which the crop roots are growing. In some cases, fertilizers may also be spray-applied directly to the crop's foliage. Irrespective of the manner of application, fertilizers are used to supply elements known to be essential to plant growth and health.

Some of these essential elements, such as carbon, hydrogen, and oxygen, are provided to plants naturally through soil, water, and photosynthetic respiration. Other essential elements, such as nitrogen, phosphorus, and potassium are also provided in relatively high amounts, and therefore are described as macronutrients. Calcium, magnesium, and sulfur, commonly expressed as secondary nutrients, are provided in smaller amounts to plants by the soil itself, or added to the plant through fertilizer inputs. Yet other essential elements, including zinc, iron, manganese, copper, boron, molybdenum, nickel, and chlorine, are known as micronutrients These essential elements are required in relatively low amounts and are also commonly provided by soil and fertilizer inputs.

Effective fertilizer formulations can also contain soil amendments that positively affect soil health and plant phenology. Humic acid is a naturally occurring organic matter source, obtained from oxidized coal; and, it is commonly utilized as a soil amendment. Naturally occurring sources of humic acids are derived from coal, lignite, and leonardite, which are widely used in agricultural applications.

Humic acids have been described as decomposed plant biomass, which undergo lignin conversion and biodegradation to form coal. A structural formula of a humic acid (proposed by Stevenson 1982) is shown below.

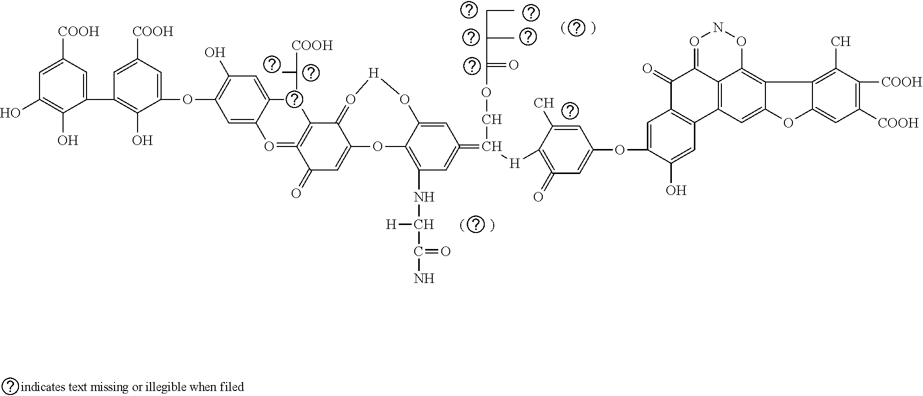

Upon conversion to coal, natural processes in soil mineralogy successively convert the aforementioned substance to peat, brown coal, bituminous coal, and finally into anthracite. These substances contain humic material, which comprises dark, insoluble solids, with molecular weights ranging from about 300 to 10,000 daltons (Da). The chemical structure of humic acids is thought to be composed of aromatic cyclic rings, bonded with carboxylic acid groups. These molecules contain a large number of carbonyl, phenolic, and hydroxyl groups. Aside from sodium, potassium, and ammonium humates, humic metallic salts are generally water insoluble.

The conventional method to produce an aqueous humic acid solution is through the introduction of a caustic extractant. The extractants, most commonly used in an aqueous form, are sodium hydroxide, potassium hydroxide, or ammonium hydroxide. Humates dissolved in an extracting solution are refined and separated from insoluble slag found in the virgin humic ore. The pH of the extracting solution must be maintained as a pH basic solution to prevent colloidal coagulation of the humic acid molecules.

It is generally known that humic acids formulated by using the aqueous caustic extraction method pose functional incompatibilities with many agricultural chemicals. These chemicals include fertilizers, pesticides, adjuvants, soil amendments, plant growth regulators, and other beneficial agricultural inputs. Such incompatibilities stem from a lack of solubility both in acidic solutions, and in solutions containing high ionic concentrations of monovalent, divalent, and trivalent cations, specifically calcium, magnesium, manganese, iron, zinc, and copper. As a result, humic acids extracted conventionally using an aqueous caustic solution must be applied separately to an agricultural crop, to avoid chemical and physical incompatibilities with other fertilizers and soil amendments.

Therefore, the need exists for improved methods of producing humic acids for use as agricultural fertilizers or as soil amendments, which can be successfully applied with other fertilizers or soil amendments.

The need further exists for humic acid compositions which are chemically and physically compatible with other fertilizers having any acidity or alkalinity (pH), electrical conductivity (EC), or concentration.

These and other objects of the present invention will be discussed in more detail below in the textual and graphical explanations which follow.

### SUMMARY OF THE INVENTION

It is an object of the present invention to improve the functional compatibilities of humic acids with acidic solutions, and solutions of all pH values containing monovalent, divalent, and trivalent cations. Specifically, an aqueous humic acid solution is emulsified using a microemulsion process. Next, that emulsified humic acid is combined with carboxylic acid. Lastly, the acidified solution is settled and refined, removing any remaining particulate matter. This results in a humic acid compatible with fertilizers of all pH, EC, and concentrations.

Set forth below is a summary of the steps of the method for making such a humic acid microemulsions The first constituent, tall oil (CAS #8002-26-4), contains three major components: resin acid, fatty acids, and unsaponifiables. Tall oil is commonly known in the industry as “tallol” or “liquid resin”.

The resin acid in tall oil is a mixture of organic acids derived from oxidation and polymerization reactions of terpenes commonly found in softwoods, hardwoods, and conifers. The main resin acids in tall oil are abietic acid and pimaric acid. The general structural formulas of these acids are shown below: abietic acid (see, Formula I); and pimaric acid (see, Formula II).

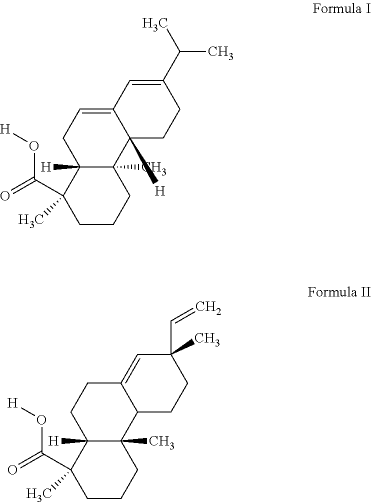 [SMILES: CC(C)C1=CC2=CC[C@@H]3[C@](C)(CCC[C@@]3(C)C(=O)O)[C@H]2CC1 ; C=C[C@@]1(C)C=C2CC[C@H]3[C@](C)(C(=O)O)CCC[C@@]3(C)C2CC1]

The fatty acids contained within tall oil are long chain monocarboxylic acids which are made up of fats and oils. The aforementioned compounds are commonly found in both softwoods and hardwoods. The primary fatty acids contained within tall oil are oleic acid, palmitic acid, and linoleic acid. The general structural formulas of these fatty acids are shown below: oleic acid (see, Formula III); palmitic acid (see, Formula IV); and linoleic acid (see, Formula V).

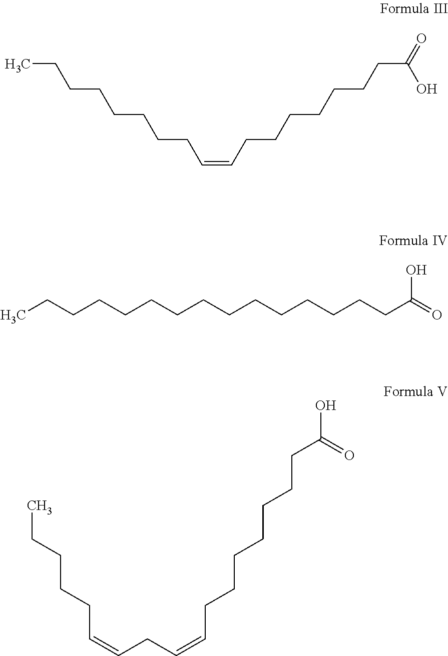 [SMILES: CCCCCCCC/C=C\CCCCCCCC(=O)O ; CCCCCCCCCCCCCCCC(=O)O ; CCCCC/C=C\C/C=C\CCCCCCCC(=O)O]

Unsaponifiables are neutral compounds which do not react with caustic hydroxides to form salts. Thus, they cannot undergo saponification to form “soap.” These neutral compounds generally contain hydrocarbons, high alcohols, and sterols. Sterols are compounds having the general structural formula shown below (see, Formula VI).

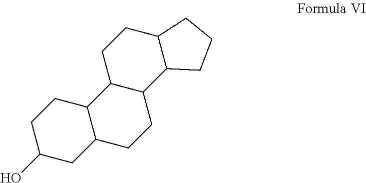 [SMILES: OC1CCC2C(CCC3C4CCCC4CCC23)C1]

The general chemical formulas for the amino primary alcohols: monoethanolamine (see, Formula VII); diethanolamine (see, Formula VIII); and, triethanolamine (see, Formula IX), are shown below.

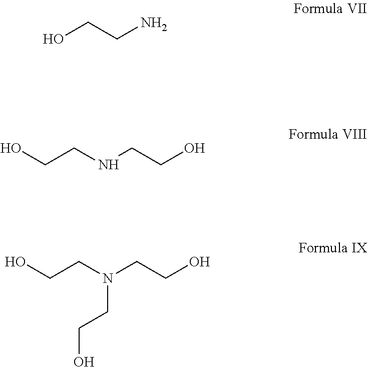

In some embodiments of the invention, the method for making an emulsion includes mixing a known concentration of tall oil, which contains fatty acids, resin acids, and unsaponifiables, with an aqueously caustic extracted humic acid, to which a primary amino alcohol is added. Upon the addition of a primary amino alcohol, a reaction occurs spontaneously with the tall oil fatty acids, preferably oleic acid, resulting in the formation of an ethanolamine oleate. Ethanolamine oleates are ionic soaps, having been used in multiple industries for their unique surfactant properties.

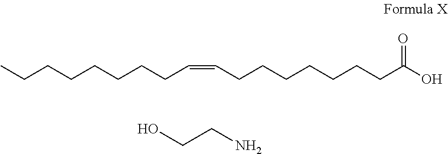

Formula X shows the general structural formula of an ethanolamine oleate formed when the above described reaction occurs when a primary amino alcohol, specifically monoethanolamine (shown in Formula VII) is added to oleic acid (shown in Formula III). It should be noted that diethanolamine or triethanolamine could also be used in place of the monoethanolamine.

The method for producing the humic acid microemulsions is continued by acidification of the solution, using a carboxylic acid. The preferred pH range of the acidification with carboxylic acid is pH 2.00-6.50. Upon acidification, the extracted caustic humate present in the aforementioned ethanolamine oleate soap is precipitated. During the settling process, the humate substance forms an emulsion between the aqueous and oil phases of the solution.

This emulsion exhibits a complete compatibility with acidic solutions, and solutions containing monovalent, divalent, and trivalent cations.

### DETAILED DESCRIPTION OF THE PREFERRED EMBODIMENT

The humic acid fertilizer of the present invention and the method of making same, require mixing an aqueous solution and adding certain components and chemical formulations in a certain order and under certain controlled circumstances. Manufacturing the humic acid composition and carrying out the manufacturing steps also require that, after the aqueous solution is mixed and amended, it be settled or centrifuged for clarification and purity. The previously mentioned objects and features of the invention are accomplished by carrying out the steps set forth following, respecting the preferred embodiment.

Following a description of the steps, specific examples embodying the principles of the present invention are also set forth. In some of these examples, the performance of the present invention is compared to conventional, extracted humic acid, considering a number of important parameters. In other examples, mixing functionality and compatibility of the present invention is shown, respecting a number of different compounds.

Lastly, efficacy tests results are presented, which compare production performance of control groups of plants and other comestibles, treated with conventional fertilizer with other identical groups treated with the humic acid fertilizer of the present invention in combination with the conventional fertilizer.

### A. MIXING STEPS

Naturally occurring ore must first be subjected to a caustic extraction process, to obtain a usable form of humic acid. Thus, the process of the present invention commences with the steps of placing a known quantity of water into a liquid mixing tank, adding in a known quantity of a caustic hydroxide extractant, and mixing these components until a homogenous solution is obtained. The mix vessel suitable may be from any means, and it is not necessary to provide specialized equipment to obtain the initial solution. However, it is preferable to have a mixing tank of sufficient capacity to hold at least one thousand gallons of water, provided with a vortex breaker to prevent overflow and poor homogenization of the solution.

The preferred source of humic acid, leonardite, is then added to the solution. To avoid coagulation of the leonardite ore in the solution prior to full extraction, small amounts are added slowly over the course of time (approximately one (1) hour for the volume discussed above). To facilitate the process, the preferable particle size of the humic acid bearing ore, leonardite, should be smaller than twenty mesh in screen size.

The mixture is allowed to extract for approximately two (2) hours in order to dissolve substantially all of the ore. During this initial mix step, the pH of the solution is closely monitored, ensuring that an overall pH in the range of 7.00-12.00 is obtained, thus ensuring a higher amount of total extractable fines. The optimum pH level is approximately 9.50.

Next, the preferred source of a primary alcohol, monoethanolamine (MEA) is added to the solution. The solution is allowed to mix for approximately ten (10) minutes in order to homogenize completely.

The solution is then emulsified by mixing it with an aqueous solution of crude tall oil. This solution is mixed for one (1) hour, resulting in the saponification of the unsaponifiables which are naturally found within crude tall oil, along with the formation of ethanolamine oleate, a natural soap. The pH and temperature of this resulting mixture are closely monitored during the process. The optimum pH for the creation of the preferred embodiment, at this juncture, is 9.00. Due to the reaction of tall oil with caustic hydroxides and monoethanolamine, an exothermic reaction ensues, resulting in a temperature of 100 degrees Fahrenheit and above.

The solution is gently agitated by impeller until the solution cools down to an ambient temperature, in the range of 68-75 degrees Fahrenheit. This allows a full reaction of the products in the solution.

The preferred carboxylic acid, having the parent chemical formulation R—COOH (where R designates the functional group), citric acid is then added to the solution. Citric acid is added to the mix tank slowly, and the pH is monitored to avoid over or under acidification. The optimum pH is in the range of 5.00-7.00.

Once the optimum pH is reached, the solution continues to be gently agitated for one (1) hour, or until the liquid solution is completely homogenous.

Optionally, a biological stabilizing agent, such as 1,2-Benzisothiazolin-3-one (Proxel GXL was used in some of the Examples below), may be added to increase overall stability of the solution.

### B. SETTLING AND REFINEMENT

Upon completing of the mixing steps, this completed solution is transferred to holding tanks provided with one or more impellers. The impellers allow this mixture to circulate, preventing the solids from precipitating, and keeping the mixture homogenous.

It is preferred that the holding tanks of sufficient capacity to hold in excess of one thousand (1000) gallons of mixture described above, are subsequently equipped with agitating propellers to prevent settling or poor homogenization of the solution. The mixture is agitated within the holding tanks for approximately one (1) hour.

Upon completion of this agitation process, the mixture is transferred to a decanter centrifuge. Decanter centrifuges, such as the Sharples Model P-3500 or equivalent, operate by separating solids from 1 or 2 liquid phases contained within a solution.

Leonardite, and other humic acid bearing ores, naturally contain insoluble fractions that have historically been removed via gravity settling. Although the process of gravity settling is sufficient to remove the insoluble fractions, such requires exceedingly long periods of time to complete. The design and implementation of decanter centrifuges decrease the processing time, and increase the manufacturing through put.

The mixture is pumped through the decanter centrifuge at a preferred speed of ten (10) to forty (40) gallons per minute. The optimum speed is twenty-five (25) gallons per minute. The decanter centrifuge may operate at one thousand (1000) to four thousand (4000) revolutions per minute (RPM); however, but the preferred speed is eighteen hundred (1800) RPM. The resulting solution is ninety percent (90%) clear of insoluble solids.

Further refinement and removal of the final insoluble fractions are required to achieve the final microemulsions. Conical plate, commonly known as disc centrifuges, possess a series of conical discs which produce and provide a parallel configuration of centrifugation space. Due to the high speed and immense centrifugal force, conical disc centrifuges remove fine insolubles from liquids to separate the liquid phases.

To achieve the removal of the final insoluble fractions, the refined solution is passed through at least one (1) conical plate centrifuge. Under a standard duration of ten (10) minutes between bowl blow down, at a consistent rate of fifteen (15) gallons per minute (GPM), the aforementioned liquid is pumped through the conical disc centrifuges to remove the final insoluble fractions. It will be understood that additional conical plate centrifuges may be employed in this step in order to decrease the time required for removal of the final insoluble fractions and thereby increase the through put volume of the microemulsions.

This completely refined solution, a humic acid microemulsion fertilizer, is subsequently transferred to storage tanks.

### C. EXAMPLES

### Example 1

Example 1 illustrates the experimental design and determination of the surface tension parameters of the humic acid liquid. Surface tension, traditionally measured in millinewtons per meter (mN/m) at 25 degrees celsius, is a measurement of cohesive forces between liquid molecules. More commonly, it is defined as the elastic tendency for liquid molecules to attract other liquid molecules (Cohesion) versus the attraction of liquid molecules to molecules in the air (Adhesion). Water at 25 degrees celsius has a surface tension of 72 millinewtons per meter.

Humic acids were dissolved in an aqueous caustic extractant in order to compare known surface tensions. Twenty-one (21) grams of humic acid were dissolved in 56.30 grams of water and 4.37 grams of potassium hydroxide. The mixture was mixed for 1 hour, to extract fully the soluble portion of humic acids. After 1 hour, the mixture was centrifuged for 10 minutes at 2000 revolutions per minute. The supernatant, or soluble fraction, was retained, and compared to the present invention. A bubble tensiometer, an instrument used to determine the dynamic surface tension of a liquid, was employed to compare the liquids.

TABLE 1
Dynamic Surface Tension

| Compound | % Humic Acid | mN/m |
|---|---|---|
| Water | 0 | 72 |
| 12% Humic Acid | 12 | 63 |
| 12% Humic Acid* | 12 | 61 |
| 6% Humic Acid | 6 | 67 |
| Present Invention | 6 | 47 |
| Present Invention | 12 | 42 |

*With compatibility agent for fertilizer compatibility

### Example 2

Example 2 illustrates the dynamic surface tension of the present invention with varying rates of crude tall oil and an ethanolamine, expressed in percent weight by weight (% w/w). The amount of humic acid extracted is consistent, at 12 percent. Composition of the various formulations were prepared and extracted according to the procedure set forth in Example 1 discussed above.

TABLE 2
Present Invention - Dynamic Surface Tension

| Compound | % w/w Crude Tall Oil | % w/w MEA | mN/m |
|---|---|---|---|
| 1 | 1.00 | 1.00 | 56.50 |
| 2 | 2.00 | 2.00 | 53.25 |
| 3 | 3.00 | 3.00 | 52.00 |
| 4 | 4.00 | 4.00 | 42.50 |
| 5 | 5.00 | 5.00 | 42.00 |
| 6 | 7.00 | 7.00 | 30.00 |
| 7 | 10.00 | 10.00 | 14.00 |

This example illustrates that a formulation of the present invention having a lower surface tension is achievable using the correct ratio of crude tall oil to monoethanolamine (MEA). A lower surface tension allows the present invention to remain fluid, showcasing a favorable thixotropic condition.

As the dynamic surface tension dropped below 50, a noticeably increased compatibility with solutions containing high ionic concentrations of monovalent, divalent, and trivalent cations was observed.

Microemulsions are described as thermodynamically stable optically isotropic systems. They are created spontaneously upon mixing water with a suitable oil compound and an amphiphile blend. Amphiphile blends can be used either be alone or in combination with a cosurfactant. Examples of amphiphiles (chemical compounds possessing hydrophilic and lipophilic properties) are soaps, detergents, and lipoproteins. Utilizing crude tall oil (Oil) dispersed in water (Aqueous) with a combination of an ethanolamine results in the formation of soap, an amphiphile. The desirable ratio of amphiphile to humic acid is illustrated above, resulting in the positive formation of a microemulsion.

### Example 3

Example 3 illustrates the pH and surface tension of the present invention with varying rates of acidifying carboxylic acids. The amount of humic acid extracted is consistent at 12 percent. The ability of the formed liquid solution was then evaluated on compatibility with high ionic fertilizers. Compatibility with all of the fertilizers tested is indicated with a plus symbol (“+”); lack of compatibility with any of the fertilizers tested is indicated with a minus symbol (“−”).

TABLE 3
Present Invention pH & Dynamic Surface Tension

| Compound | % w/w Acid | pH | mN/m | Compatibility |
|---|---|---|---|---|
| Citric Acid | 9.68 | 4.93 | 42.50 | + |
| Citric Acid | 5.00 | 9.82 | 33.50 | − |
| Citric Acid | 3.00 | 10.83 | 30.00 | − |
| Acetic Acid | 5.00 | 9.69 | 32.00 | − |
| Acetic Acid | 7.00 | 7.29 | 26.50 | − |
| Formic Acid | 5.00 | 8.92 | 34.00 | − |
| Formic Acid | 7.00 | 4.99 | 45.50 | + |

This example illustrates that a pH value below neutral is most preferable for compatibility with liquid fertilizers and other chemistries.

### Example 4

Example 4 illustrates the compatibility of the present invention compared to traditional humic acids that are commercially available. Samples consisting of approximately fifty (50) ml of fertilizer were prepared in clear test-tubes for compatibility testing. Five (5.0) ml was pipetted into each respective test-tube. The results, which were visually rated for solubility, were given a “solubility rating” of “+++” (highest solubility) to “−” (lowest solubility).

TABLE 4
Solubility Of Present Invention Compared To Humic Acids

| | Present | 12% Humic | 6% Humic |
|---|---|---|---|
| Fertilizer | Invention | Acid | Acid |
| Ammonium Polyphosate | +++ | ++ | ++ |
| Ammonium Thiosulfate | +++ | ++ | ++ |
| Calcium Thiosulfate | +++ | − | − |
| Calcium Nitrate | +++ | − | − |
| Calcium Ammonium Nitrate | +++ | − | − |
| Urea Ammonium Nitrate | +++ | ++ | ++ |
| Phosphoric Acid | +++ | − | − |
| Urea Sulfuric Acid | +++ | − | − |

### Example 5

This example illustrates the benefits of a formulation of the present invention with CAN 17 (a liquid double salt of calcium ammonium nitrate 17% nitrogen) that is traditionally used in production agriculture. A composition of leonardite (65 wt. % humic acid), potassium hydroxide, crude tall oil, monoethanolamine, citric acid, and Proxel GXL, mixed with CAN-17, was prepared by percentage weight by weight as shown in Table 5. The resulting concentrations of calcium, nitrogen, and humic acid for this composition are also displayed in this Table.

TABLE 5
Present Invention with CAN-17

| Compound | % w/w |
|---|---|
| Water | 48.93 |
| Leonardite | 7.87 |
| Potassium Hydroxide | 3.33 |
| Crude Tall Oil | 3.75 |
| Monoethanolamine | 3.75 |
| Citric Acid | 7.26 |
| Proxel GXL | 0.11 |
| CAN-17 | 25.00 |
| % Calcium | 2.20 |
| % Nitrogen | 4.25 |
| % Humic Acid | 5.10 |

As evident from this example, this composition provides the benefits of the calcium, nitrogen, and humic acid in one single product. Due to the present invention, the calcium does not bond with the phenolic or carboxylic groups of the humic acid which otherwise would produce an insoluble calcium humate. Traditionally, calcium and humic acid fertilizers are incompatible, due to alkaline pH and chemical interactions.

### Example 6

This example illustrates the benefits of a formulation of present invention with a higher percentage of CAN 17 than used in Example 5. A composition of leonardite (65 wt. % humic acid), potassium hydroxide, crude tall oil, monoethanolamine, citric acid, and Proxel GXL, mixed with CAN-17, was prepared as shown in Table 6. The resulting concentrations of calcium, nitrogen, and humic acid for this composition are also displayed in this Table.

TABLE 6
Present Invention with CAN-17

| Compound | % w/w |
|---|---|
| Water | 16.31 |
| Leonardite | 2.62 |
| Potassium Hydroxide | 1.10 |
| Crude Tall Oil | 1.25 |
| Monoethanolamine | 1.25 |
| Citric Acid | 2.42 |
| Proxel GXL | 0.03 |
| CAN-17 | 75.00 |
| % Calcium | 6.60 |
| % Nitrogen | 12.75 |
| % Humic Acid | 1.70 |

This composition also provides the benefits of the calcium, nitrogen, and humic acid in one single product. Due to the present invention, the calcium does not bond with the phenolic or carboxylic groups of the humic acid which otherwise would produce an insoluble calcium humate. Traditionally, calcium and humic acid fertilizers are incompatible, due to alkaline pH and chemical interactions. In agronomic settings, a higher ratio of macronutrient fertilizers is utilized compared to humic acids. This example showcases a compatible blend, incorporating the present invention, that is desirable.

### Example 7

This example illustrates a formulation of the present invention with Urea Sulfuric Acid, an acidic fertilizer that is traditionally used in production agriculture. A composition of leonardite (65 wt. % humic acid), potassium hydroxide, crude tall oil, monoethanolamine, citric acid, and Proxel GXL mixed with Urea Sulfuric Acid, was prepared as shown in Table 7. The resulting concentrations of sulfur, nitrogen, and humic acid, and the pH, for this composition are also displayed in this Table.

TABLE 7
Present Invention with Urea Sulfuric Acid

| Compound | % w/w |
|---|---|
| Water | 16.31 |
| Leonardite | 2.62 |
| Potassium Hydroxide | 1.10 |
| Crude Tall Oil | 1.25 |
| Monoethanolamine | 1.25 |
| Citric Acid | 2.42 |
| Proxel GXL | 0.03 |
| Urea Sulfuric Acid | 75.00 |
| % Sulfur | 12.00 |
| % Nitrogen | 11.25 |
| % Humic Acid | 1.70 |
| pH | <1.00 |

This composition provides the benefits of an acid fertilizer and humic acid in one single product. Urea Sulfuric Acids are employed in agronomic settings to prevent scale build up in irrigation equipment (calcium carbonate, calcite) that will precipitate and build up over the course of fertilizer injections. Humic acid, being acid insoluble, traditionally cannot be co-applied with acids. The formulation in this example evidences a compatible blend that is desirable in an agronomic setting, wherein the humic acid's phenolic and carboxylic groups will not adversely react in low pH environments which would otherwise result in a flocculated or precipitated humate.

### D. EFFICACY TESTS

Applicant conducted efficacy trials to study the effects of the present invention on yields of various crops. Depending upon the crop, either four (4) or six (6) replications of the tests were conducted.

In these trials, the number of replications refers to: the number of plots in the control group receiving treatment with a fertilizer only; and, the number of plots in the group which received treatment with the fertilizer and the present invention. For example, six (6) replications means that there were six (6) fertilizer only plots and six (6) plots treated with the fertilizer plus the present invention. Each of the treatment replications were identical and treatments were placed randomly to account for spatial variability that may occur in the trial area. The final yield numbers were determined by averaging the results of the replications for each treatment.

The results of these trials are set forth in the following Tables. For each of the Tables, the first column of the first row of data sets forth the type of fertilizer and the amount of that fertilizer applied per acre. The first column of the second row of data specifies the amount of the present invention, which was mixed with that same type and amount of the fertilizer, and then applied per acre.

One (1) set of trials consisting of six (6) replications each was conducted on certain row crops. In these trials, a fertilizer only was applied to a control group of the crops and the present invention was applied along with the fertilizer to a second group of crops. Applications of the fertilizer, and the present invention—fertilizer mix, were done in-furrow at the time of planting.

CORN - Applied In-Furrow At Planting
Six (6) Replications Per Treatment/Trial
Yield In Bushels Per Acre

| | 230 | 230.5 | 231 | 231.5 | 232 | 232.5 | 233 | 233.5 | 234 | 234.5 |
|---|---|---|---|---|---|---|---|---|---|---|
| 10-34-0 Fertilizer | | | | | | | | | | |
| @ 5 Gal/Acre 231.5 | | | | 231.5 | | | | | | |
| 1 Quart/Acre | | | | | | | | | | |
| Present Invention | | | | | | | | | 234 | |

CORN - Applied In-Furrow At Planting
Six (6) Replications Per Treatment/Trial
Yield In Bushels Per Acre

| | 214 | 216 | 218 | 220 | 222 | 224 | 226 | 228 | 230 |
|---|---|---|---|---|---|---|---|---|---|
| 6-24-6 Fertilizer | | | | | | | | | |
| @ 5 Gal/Acre | | | | 219.1 | | | | | |
| 1 Quart/Acre | | | | | | | | | |
| Present Invention | | | | | | | | 227.6 | |

SOYBEAN - Applied In-Furrow At Planting
Six (6) Replications Per Treatment/Trial
Yield In Bushels Per Acre

| | 59 | 60 | 61 | 62 | 63 | 64 | 65 | 66 | 67 | 68 | 69 |
|---|---|---|---|---|---|---|---|---|---|---|---|
| 10-34-0 | | | | | | | | | | | |
| Fertilizer | | | | | | | | | | | |
| @ 3 Gal/Acre | | | | | 62.5 | | | | | | |
| 1 Quart/Acre | | | | | | | | | | | |
| Present | | | | | | | | | | 67.7 | |
| Invention | | | | | | | | | | | |

POTATO - Applied In-Furrow At Planting
Six (6) Replications Per Treatment/Trial
Yield In Hundredweight (CWT) Per Acre

| | 510 | 520 | 530 | 540 | 550 | 560 | 570 |
|---|---|---|---|---|---|---|---|
| 6-24-6 Fertilizer | | | | | | | |
| @ 5 Gal/Acre | | | 529 | | | | |
| 1 Gallon/Acre | | | | | | | |
| Present Invention | | | | | | | 567 |

POTATO - Applied In-Furrow At Planting
Six (6) Replications Per Treatment/Trial
Yield In Hundredweight (CWT) Per Acre

| | 355 | 360 | 365 | 370 | 375 | 380 | 385 | 390 |
|---|---|---|---|---|---|---|---|---|
| 6-24-6 | | | | | | | | |
| Fertilizer | | | | | | | | |
| @ 5 Gal/Acre | | | | 367 | | | | |
| 1 Gallon/Acre | | | | | | | | |
| Present | | | | | | | 384 | |
| Invention | | | | | | | | |

A second set of trials, consisting of four (4) replications each, was conducted on almonds and on wine grapes. In these trials, a fertilizer only was applied to a control group of the crops and the present invention was applied along with the fertilizer to a second group of crops. Application of the fertilizer, and the present invention—fertilizer mix, was done by injection into drip irrigation, and was applied in the Spring and the Fall. With respect to the trials involving almonds, treatments were applied at early root flush (Spring) and late root flush (Fall).

ALMOND - Applied Via Injection
Four (4) Replications Per Treatment/Trial
Nut Meat Yield In Ounces Per 100 Opened (Or Cracked) Nut

| | 6.20 | 6.40 | 6.60 | 6.80 | 7.00 | 7.20 | 7.40 | 7.60 | 7.80 | 8.00 |
|---|---|---|---|---|---|---|---|---|---|---|
| CAN-17 Fertilizer | | | | | | | | | | |
| @ 50 Gal/Acre | | | | 6.76 | | | | | | |
| 1 Quart/Acre | | | | | | | | | | |
| Present Invention | | | | | | | | | 7.77 | |

ALMOND - Applied Via Injection
Four (4) Replications Per Treatment/Trial
Yield In Pounds Per Acre

| | 1500 | 1550 | 1600 | 1650 | 1700 | 1750 | 1800 | 1850 |
|---|---|---|---|---|---|---|---|---|
| UAN 32-0-0 | | | | | | | | |
| Fertilizer | | | | | | | | |
| @ 160 Gal/Ac | | | 1600 | | | | | |
| 1 Quart/Acre | | | | | | | | |
| Present | | | | | | | 1793 | |
| Invention | | | | | | | | |

WINE GRAPES - Applied Via Injection
Four (4) Replications Per Treatment/Trial
Yield In Pounds Per Acre

| | 6350 | 6360 | 6370 | 6380 | 6390 | 6400 | 6410 | 6420 |
|---|---|---|---|---|---|---|---|---|
| UAN 32-0-0 | | | | | | | | |
| Fertilizer | | | | | | | | |
| @ 15 Gal/Acre | | | | 6378 | | | | |
| 1 Gallon/Acre | | | | | | | | |
| Present | | | | | | | | 6416 |
| Invention | | | | | | | | |

WINE GRAPES - Applied Via Injection
Four (4) Replications Per Treatment/Trial
Yield In Tons Per Acre

| | 4.8 | 5.0 | 5.2 | 5.4 | 5.6 | 5.8 | 6.0 | 6.2 | 6.4 | 6.6 | 6.8 |
|---|---|---|---|---|---|---|---|---|---|---|---|
| UAN 32-0-0 Fert. | | | | | | | | | | | |
| @32 Gal/Acre | | | | | 5.5 | | | | | | |
| 1 Gallon/Acre | | | | | | | | | | | |
| Present Invention | | | | | | | | | | 6.6 | |

WINE GRAPES - Applied Via Injection
Four (4) Replications Per Treatment/Trial
Yield In Tons Per Acre

| | 2.80 | 2.85 | 2.90 | 2.95 | 3.00 | 3.05 | 3.10 | 3.15 |
|---|---|---|---|---|---|---|---|---|
| UAN 32-0-0 | | | | | | | | |
| Fertilizer | | | | | | | | |
| @ 14 Gal/Acre | | | 2.90 | | | | | |
| 1 Gallon/Acre | | | | | | | | |
| W/Present | | | | | | | 3.10 | |
| Invention | | | | | | | | |

A final set of trials were conducted using fertilizer only on the control group and the present invention—fertilizer mix, for process tomato plants. In this instance the fertilizer only, and the present invention—fertilizer mix, were applied to the soil at the time of transplanting. The trials consisted of four (4) replications.

PROCESS TOMATO - Applied Pre-Plant
Four (4) Replications Per Treatment/Trial
Yield In Tons Per Acre

| | 28.0 | 28.5 | 29.0 | 29.5 | 30.0 | 30.5 |
|---|---|---|---|---|---|---|
| UAN 32-0-0 Fertilizer | | | | | | |
| @ 10 Gal/Acre | | | 28.8 | | | |
| 1 Gallon/Acre | | | | | | |
| Present Invention | | | | | | 30.3 |

What is claimed is:

1. A method for forming a humic acid fertilizer, comprising the steps of:
Mixing together water with a caustic hydroxide extractant in a mixing container until a substantially homogenous solution is obtained;
Successively adding small amounts of particulate humic acid bearing ore to said solution and mixing continuously over a period of time so as to avoid coagulation of the ore in said solution, said ore being extracted and substantially dissolved while the pH of said solution is monitored and maintained in the range of 7.00-12.00;
Adding a primary alcohol to said solution and mixing said solution until it is homogeneous;
Adding tall oil to said solution and mixing said solution until saponification of unsaponifiables contained in said tall oil occurs and ethanolamine oleate forms, emulsifying said solution;
Agitating said solution until it cools down to an ambient temperature, in the range of approximately 68-75 degrees Fahrenheit;
Adding a carboxylic acid to said solution while agitating said solution to be homogeneous, and metering the amount and rate of added acid to maintain a pH for said solution in the range of approximately 5.00-7.00;
Removing a first group of relatively large insoluble fractions from said solution, by continuously pumping said solution through at least one decanter centrifuge; and,
Removing a second group of relatively fine insoluble fractions from said solution, by continuously pumping said solution through at least one conical plate centrifuge, resulting in a humic acid fertilizer.

2. The method of claim 1 in which said caustic hydroxide extractant is selected from the group comprising sodium hydroxide, potassium hydroxide, or ammonium hydroxide.

3. The method of claim 1 in which said particulate humic acid bearing ore comprises leonardite having a screen size smaller than twenty (20) mesh.

4. The method of claim 1 in which said carboxylic acid is citric acid, and in which said citric acid has a pH preferably in the range of 2.00-6.50.

5. The method of claim 1 further including the step of adding a biological stabilizing agent to said solution after the step of adding a carboxylic acid, and said solution has reached a pH within the range of 5.00 to 7.00.

6. The method of claim 5, in which said biological stabilizing agent comprises 1.2-Benzisothiazolin-3-one.

7. The method of claim 1 in which said primary alcohol is monoethanolamine.

8. The method of claim 1 in which said primary alcohol is either diethanolamine or triethanolamine.

9. A humic acid fertilizer comprising:
a homogenous aqueous solution of caustic hydroxide extract;
particulate humic acid bearing ore dissolved in said aqueous solution having a pH in the range of 7.00-12.00;
a primary alcohol mixed into said solution until it is homogeneous;
tall oil mixed into said solution until saponification of unsaponifiables contained in said tall oil occurs and ethanolamine oleate forms, emulsifying said solution;
a carboxylic acid mixed into said solution until it is homogeneous and acidified having a pH in the range of approximately 5.00-7.00;
in which a first group of relatively large insoluble fractions is removed from said solution, by continuously pumping said solution through at least one decanter centrifuge, and in which a second group of relatively fine insoluble fractions is removed from said solution, by continuously pumping said solution through at least one conical plate centrifuge.

10. The humic acid fertilizer of claim 9 in which said caustic hydroxide extractant is selected from the group comprising sodium hydroxide, potassium hydroxide, or ammonium hydroxide.

11. The humic acid fertilizer of claim 9 in which said particulate humic acid bearing ore comprises leonardite having a screen size smaller than twenty (20) mesh.

12. The humic acid fertilizer of claim 9 in which said carboxylic acid is citric acid, and in which said citric acid has a pH preferably in the range of 2.00-6.50.

13. The humic acid fertilizer of claim 9 further including a biological stabilizing agent mixed into said solution after being acidified and reaching a pH in the range of 5.00 to 7.00.

14. A method for forming a humic acid fertilizer, comprising the steps of:
a. successively adding small amounts of particulate humic acid bearing ore to a homogeneous aqueous solution of a caustic hydroxide extractant and mixing continuously over a period of time so as to avoid coagulation of said ore in said solution, said ore being extracted and substantially dissolved while the pH of said solution is monitored and maintained in the range of 7.00-12.00;
b. adding a primary alcohol to said solution and mixing said solution until it is homogeneous;
c. adding tall oil to said solution and mixing said solution until saponification of unsaponifiables contained in said tall oil occurs and ethanolamine oleate forms, emulsifying said solution;
d. agitating said solution until it cools down to an ambient temperature, in the range of approximately 68-75 degrees Fahrenheit;
e. adding an acid to said solution while agitating said solution to be homogeneous, and metering the amount and rate of said acid added to maintain a pH for said solution in the range of approximately 5.00-7.00; and,
f. removing insoluble fractions from said solution, by continuously pumping said solution through at least one centrifuge, resulting in a humic acid fertilizer.

15. The method of claim 14 in which said caustic hydroxide extractant is selected from the group comprising sodium hydroxide, potassium hydroxide, or ammonium hydroxide.

16. The method of claim 14 in which said particulate humic acid bearing ore comprises leonardite having a screen size smaller than twenty (20) mesh.

17. The method of claim 14 in which said acid added to said solution in step e is a carboxylic acid.

18. The method of claim 17 in which said carboxylic acid is citric acid, and in which said citric acid has a pH preferably in the range of 2.00-6.50.

19. The method of claim 14 in which said primary alcohol is monoethanolamine.

20. The method of claim 14 in which said primary alcohol is either diethanolamine or triethanolamine.
